(19) United States
(12) Patent Application Publication
(10) Pub. No.: US 2022/0079269 A1
(43) Pub. Date: Mar. 17, 2022

(54) FACE MASK WITH TRANSPARENT PORTION

(71) Applicant: United States Government as Represented by the Department of Veterans Affairs, Washington, DC (US)

(72) Inventors: SETH HILLS, Richmond, VA (US); BRIAN BURKHARDT, Richmond, VA (US); JOHN MILLER, Richmond, VA (US); MELISSA OLIVER, Richmond, VA (US)

(21) Appl. No.: 17/187,268

(22) Filed: Feb. 26, 2021

Related U.S. Application Data
(60) Provisional application No. 63/079,270, filed on Sep. 16, 2020.

(51) Int. Cl. A41D 13/11

(52) U.S. Cl. CPC A41D 13/1161; A41D 2500/50; A41D 2500/30

(57) ABSTRACT

A mask can be used on a face of a wearer having a head, a face, a nose, and a mouth. The mask can comprise a transparent body defining a peripheral rim that is configured to engage the face of the wearer. The transparent body can be configured to simultaneously cover the mouth and the nose of the wearer. The transparent body can define at least one aperture. The transparent body can define a circumferential surface around each aperture. A respective filter media can extend across and covers each aperture of the at least one aperture. A respective retaining element can be configured to retain the respective filter media across each aperture. The circumferential surface around each aperture can be configured to cooperate with the retaining element to retain the respective filter media between the retaining element and the circumferential surface.

### CROSS-REFERENCE TO RELATED APPLICATION

This application claims priority to and the benefit of the filing date of U.S. Provisional Patent Application No. 63/079,270, filed Sep. 16, 2020, the entirety of which is hereby incorporated by reference herein.

### FIELD

This application relates to respirator devices and methods for covering a mouth and nose of a user.

### BACKGROUND

Many individuals (e.g., those who interact with medical providers and many providers themselves) rely upon lip-reading and visual cues for communication. The COVID-19 pandemic has made it difficult for these individuals to communicate due to an absence of transparent face masks. Face masks with suitable filtering capability are in short supply in general, and available alternatives that have transparent portions have deficiencies.

### SUMMARY

Described herein, in one aspect, is a mask that can be used on a face of a wearer having a head, a face, a nose, and a mouth. The mask can comprise a transparent body defining a peripheral rim that is configured to engage the face of the wearer. The transparent body can be configured to simultaneously cover the mouth and the nose of the wearer. The transparent body can define at least one aperture. The transparent body can define a circumferential surface around each aperture. A respective filter media can extend across and covers each aperture of the at least one aperture. A respective retaining element can be configured to retain the respective filter media across each aperture. The circumferential surface around each aperture can be configured to cooperate with the retaining element to retain the respective filter media between the retaining element and the circumferential surface.

A method of using the mask can comprise: positioning respective filter media across each aperture of the at least one aperture of the transparent body; and biasing the respective filter media against the circumferential surface around each aperture with a respective retaining element.

### DESCRIPTION OF THE DRAWINGS

FIG. 1 is a prior art mask that has a clear portion but does not meet surgical standards.

FIG. 2 is a prior art mask that is not reusable,

FIG. 3 is an exterior perspective view of a mask in accordance with embodiments disclosed herein.

FIG. 4 is an interior perspective view of the mask of FIG. 3.

FIG. 5 is a perspective view of the mask of FIG. 3 being worn by a user.

FIG. 6 is a schematic cross section of a portion of the mask of FIG. 3, showing details of an embodiment for retaining a filter media across an aperture,

FIG. 7 is a schematic cross section of a portion of the mask of FIG. 3, showing details of another embodiment for retaining a. filter media across an aperture.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” include plural referents unless the context clearly dictates otherwise. For example, use of the term “an aperture” can refer to one or more of such apertures.

All technical and scientific terms used herein have the same meaning as commonly understood to one of ordinary skill in the art to which this invention belongs unless clearly indicated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

The following description supplies specific details in order to provide a thorough understanding. Nevertheless, the skilled artisan would understand that the apparatus and associated methods of using the apparatus can be implemented and used without employing these specific details. Indeed, the apparatus and associated methods can be placed into practice by modifying the illustrated apparatus and associated methods and can be used in conjunction with any other apparatus and techniques conventionally used in the industry.

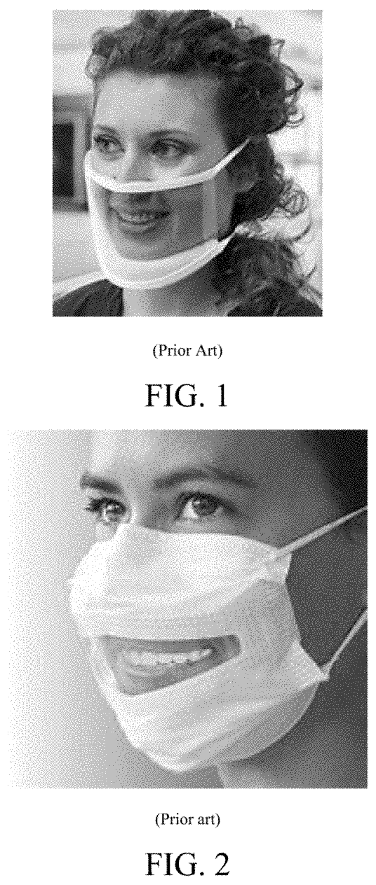

Certain transparent masks, such as the mask shown in FIG. 1, do not meet surgical mask standards, rendering them unsuitable for use as personal protective equipment. Other masks having transparent portions, such as the mask shown in FIG. 2, are not reusable, which can be particularly detrimental when supplies of personal protective equipment are limited.

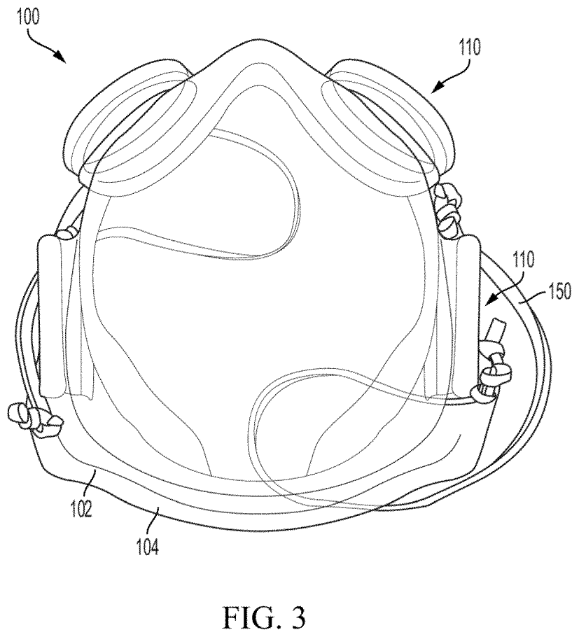

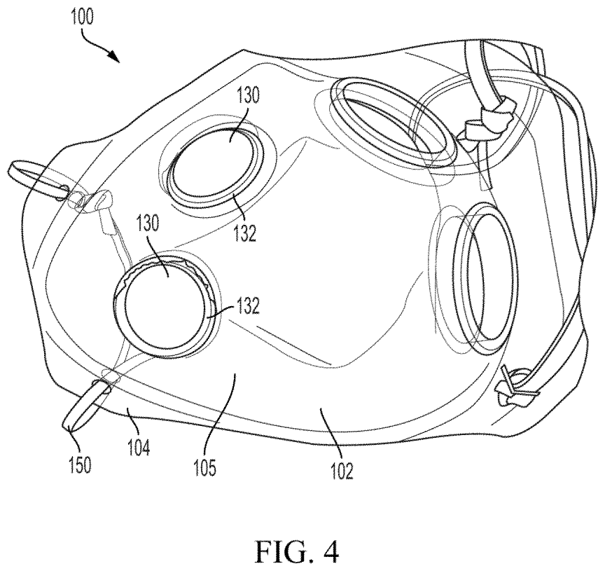

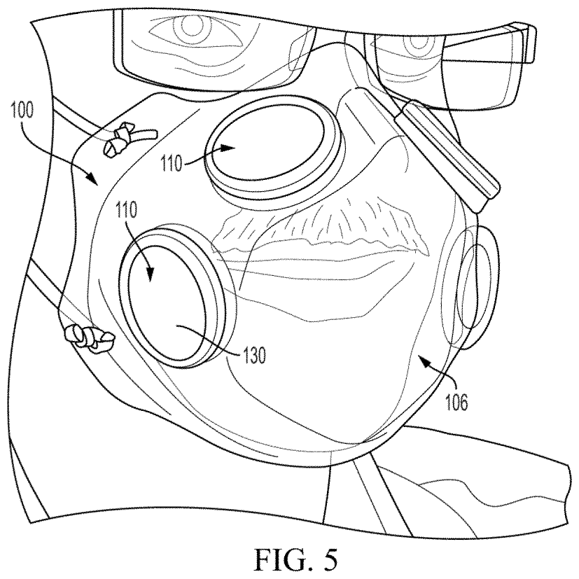

Described herein, with reference to FIGS. 3-5, is a mask 100 comprising an at least partially transparent body 102 (referred to herein as a “transparent body”) that is shaped to encompass the nose and mouth of a wearer. The transparent body 102 can be sufficiently transparent so that, when the mask 100 is covering the face of the wearer, an onlooker can distinguish lip movements of the wearer, thereby allowing the mask to be suitable for lip reading. Accordingly, it is contemplated that a material having imperfect but sufficient transparency, unless otherwise indicated, is included within the scope of the disclosure. in some aspects, the transparent body 102 can be entirely transparent in other aspects, only a central region of the body 102, through which the mouth of the wearer is visible, is transparent, and peripheral regions of the mask surrounding the central region are transparent. The transparent body 102 can define a peripheral rim 104 that is configured to engage a face of a wearer. The transparent body 102 can be configured to simultaneously cover the mouth and the nose of the wearer. The transparent body 102 can have an interior surface 105 that cooperates with the face of the wearer to enclose a space 106.

The transparent body 102 can optionally comprise polymer. For example, in optional aspects, the transparent body 102 can comprise glycol-modified polyethylene terephthalate, or PETG. Optionally, the transparent body can be rigid or semi-rigid. For example, the transparent body can have sufficient rigidity to maintain the interior surface 105 in spaced relation to the mouth of the wearer. The mask 100 can comprise a cleanable and durable material to enable reuse. The interior surface 105 of the transparent body 102 can be treated with an anti-fog solution to prevent fogging up during use.

The transparent body 102 of the mask 100 can define one or more apertures 110 (vent ports). Although four vent ports are disclosed, it is contemplated that any suitable number of apertures (e.g., 1, 2, 3, 5, 6, or more) can be used. The number of apertures 110 and the area of each aperture can cooperate to provide sufficient ventilation for a wearer. For example, in some aspects, each aperture 110 can have an area of at least one square inch, or at least 1.5 square inches, or at least 2 square inches. In further aspects, the area of each aperture can be no greater than 3 square inches, or no greater than 2 square inches. In still further aspects, a collective area defined by all of the apertures 110 can be at least three, at least four, at least five, at least seven, or at least ten square inches.

The apertures 110 can be positioned so that the apertures are not intersected by a line of sight extending from a position directly in front of the mask to the mouth of the user. In this way, the mask can enable lip reading. Optionally, in some exemplary aspects, it is contemplated that the mask can comprise a central region that is configured to overlie the mouth of a wearer relative to a sagittal axis passing through the wearer in a front-to-back direction, and the apertures can all be positioned between the central region of the mask and the peripheral rim of the mask.

The mask 100 can further comprise filter media 130 that can extend across each aperture 110. The filter media 130 can optionally be disk shaped (e.g., circular), square, rectangular, oval, or any suitable shape. Optionally, the filter media 130 can comprise a portion of a surgical mask material. Thus, as used herein, each “filter media” refers to a filter structure. In other aspects, it is contemplated that the filter media can comprise nonwoven polymer. More generally, it is contemplated that each filter media 130 can comprise any conventional filter material as is known in the art. Optionally, in some exemplary aspects, multiple types of filter media 130 can be used with a single mask, with one type of filter media positioned across at least one aperture, and at least one other type of filter media positioned across at least one other aperture.

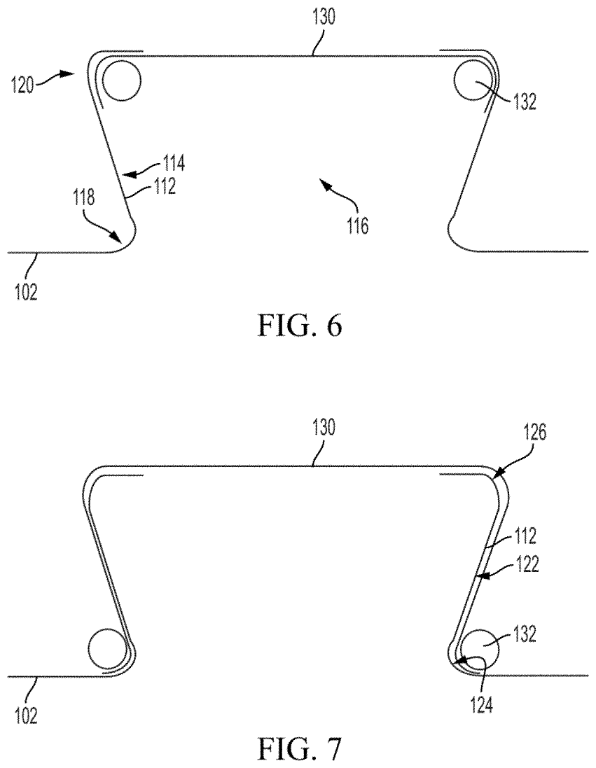

A retaining element 132 can retain each of the filter media 130 in position across the aperture 110 so that all, or substantially all, of the air that flows through the aperture can be filtered through the filter media 130. For example, referring to FIGS. 6 and 7, in some aspects, the transparent body 102 can define a circumferential surface 112 around each aperture 100. The circumferential surface 112 around each aperture 110 can be configured to cooperate with the respective retaining element to retain the respective filter media 130 between the retaining element 132 and the circumferential surface 112. As shown, the circumferential surface can be defined by an annular projection that surrounds a respective aperture.

As shown in FIG. 6. in some aspects, the circumferential surface 112 can be an inner circumferential surface 114 (that faces towards the aperture). The circumferential surface 114 can define a volume 116 (e.g., a recess) into which the filter media 130 can be received. The circumferential inner surface 114 can be configured to retain the retaining element 132 therein, thereby retaining the filter media 130 across the aperture 110. For example, the inner circumferential surface 114 can comprise a base end 118 and an opposing distal end 120 that defines the aperture 110. At least a portion of the inner circumferential surface can define a taper that produces a decreased circumference moving in a direction from the distal end 120 toward the base end 118. Optionally, in some aspects, the inner circumferential surface can have a consistent taper moving from the distal end 120 to the base end 118. In other aspects, it is contemplated that the taper can only extend along a portion of the inner circumferential surface. In other aspects, it is contemplated that the inner circumferential surface can have a variable taper. The taper can be configured to retain the retaining element with the volume 116. The retainer 132 can be an annular elastic member or shape-memory material that can be configured to bias outwardly against the inner circumferential surface (with the filter media positioned between the retainer and the inner circumferential surface). Materials having such elastic or shape-memory properties are known in the art and not described in detail herein. Accordingly, a. wearer can deform the retaining element to fit it through an opening defined by the base end 118, and the retaining element can resiliently return to its formed shape (by extending radially outwardly) to seat against the inner circumferential surface 114.

As shown in FIG. 7, in some aspects, the circumferential surface 112 can be an outer circumferential surface 122. The outer circumferential surface 122 can comprise a base end 124 and an opposing distal end 126 that defines the aperture 110. At least a portion of the outer circumferential surface 122 can define a taper that produces a decreased circumference moving in a direction from the distal end 126 toward the base end 124. Optionally, in some aspects, the outer circumferential surface 122 can have a consistent taper moving from the distal end 126 to the base end 124. In other aspects, it is contemplated that the taper can only extend along a portion of the outer circumferential surface. In other aspects, it is contemplated that the outer circumferential surface can have a variable taper. The retaining element 132 can be an annular elastic band as is known in the art. The retaining element 132 can be stretched over the distal end 126 so that the retaining element retracts (radially inwardly) against the outer circumferential surface 122 with the filter media 130 positioned therebetween.

In further aspects, the circumferential surface 112 (e.g, the inner circumferential surface or the outer circumferential surface) can define any suitable catch or engagement structure (e.g., a hook, a protrusion, an angled surface, etc.) that can retain the retaining element 132 on the circumferential surface. For example, the circumferential surface 112 can define one or more bumps, lips, or ridges that inhibit movement of the retaining clement 132 thereacross. In additional aspects, it is contemplated that the distal end 120 of the circumferential surface 114 can comprise a lip that extends over at least a portion of the aperture and overlies or overlaps with at least a portion of the retaining element 132, thereby ensuring that the retaining element remains within the volume 116 (and in engagement with the filter media). In further aspects, it is contemplated that distal end 126 of the circumferential surface 122 can comprise a lip that extends over at least a portion of the aperture and provides additional support to the portion of the filter media extending across the aperture.

It is contemplated that, in some aspects, the circumferential surfaces can be extending inwardly into the enclosed space 106 (and toward the wearer). In further aspects, the circumferential surfaces can be extending outwardly and away from the enclosed space 106 (as shown in FIGS. 3-5).

Although described herein as circumferential surfaces, it is contemplated that non-circumferential surfaces can likewise be employed to secure the filter media 130 over a respective aperture. For example, it is contemplated that a plurality of circumferentially spaced engagement structures could be used. However, in order to prevent passage of unfiltered air through the apertures, it is contemplated that the use of circumferential surfaces as disclosed herein can be advantageous.

The mask 100 can comprise one or more ties or elastic loops 150 (or other conventional strap components) for securing the mask to the head of the wearer.

A kit can comprise a transparent body 102, a plurality of filter media 130, and a plurality of retaining elements 132. Optionally, the number of filter media 130 among the plurality of filter media 130 can be at least twice (optionally, ten times or more) the number of apertures of the transparent body 102. Optionally, the retaining elements can be disposable. In further aspects, the retaining elements can be reusable and, optionally, sanitizable.

A method of preparing a mask 100 for use can comprise positioning a respective filter media 130 across each aperture of the at least one aperture of the body and biasing the respective filter media against the circumferential surface around each aperture with a respective retaining element 132.

Optionally, the filter media can be changed. For example, the respective retaining element 132 at each aperture can be disengaged, and the filter media 130 at each aperture can be removed. The transparent body 102 can optionally be cleaned or sanitized. New filter media can be positioned across each aperture 110, and a respective retaining element (new or used) can bias the respective new filter media across each aperture.

The mask 100 can be used as a surgical mask while providing a clear view of the wearer's mouth for purposes including communication via facial expression and lip-reading. The mask can be user-serviceable, cleanable, and reusable. The disclosed masks provide improvements over prior technology by enabling replacement of the filters (either using precut filter disks or with fabricated filters from the material of a surgical mask or other suitable filter material such as non-woven polymer, etc.) when the filters .have reached the end of their usable life. Non-disposable portions of the mask, such as, for example, the transparent body 102 can be cleanable/sanitizable with approved surface cleaners (e.g., CDC-approved surface cleaners) and, thus, reusable. When surgical mask material (or other similar material) is used to provide filtration, it is contemplated that the disclosed masks can further improve upon existing technology by providing filtration performance that is equivalent to a standard surgical mask. Thus, it is contemplated that the disclosed masks can provide performance that is equivalent to (or better than) a standard surgical mask while also providing a reusable mask body having. transparent portions that permit improved communication via facial expression and lip-reading.

Although the foregoing invention has been described in some detail by way of illustration and example for purposes of clarity of understanding, certain changes and modifications may be practiced within the scope of the appended claims.

What is claimed is:

1. A mask for use on a face of a wearer having a head, a face, a nose, and a mouth, the mask comprising:
a transparent body defining a peripheral rim that is configured to engage the face of the wearer, wherein the transparent body is configured to simultaneously cover the mouth and the nose of the wearer, wherein the transparent body defines at least one aperture, wherein the transparent body defines a circumferential surface around each aperture of the at least one aperture;
a respective filter media that extends across and covers each aperture of the at least one aperture; and
a respective retaining element that is configured to retain the respective filter media across each aperture,
wherein the circumferential surface around each aperture is configured to cooperate with the retaining element to retain the respective filter media between the retaining element and the circumferential surface.

2. The mask of claim 1, wherein the circumferential surface is an inner circumferential surface, wherein the inner circumferential surface is configured to retain a retaining element therein.

3. The mask of claim 2, wherein the inner circumferential surface defines a volume, wherein the inner circumferential surface comprises a base end and a distal end that defines the aperture, wherein at least a portion of the inner circumferential surface defines a taper that produces a decrease in circumference moving in a direction from the distal end toward the base end, wherein the taper is configured to retain the retaining element within the volume defined by the inner circumferential surface.

4. The mask of claim 3, wherein the retaining element is an annular elastic member that is configured to bias outwardly against the inner circumferential surface.

5. The mask of claim 2, wherein the inner circumferential surface defines a volume, wherein the inner circumferential surface defines a catch that is configured to retain the retaining element within the volume defined by the inner circumferential surface.

6. The mask of claim 2, wherein the circumferential surface comprises an outer circumferential surface.

7. The mask of claim 6, wherein the outer circumferential surface comprises a base end and a distal end that defines the aperture, wherein at least a portion of the outer circumferential surface defines a taper that produces a decrease in circumference moving in a direction from the distal end toward the base end, wherein the taper is configured to retain the retaining element on the outer circumferential surface.

8. The mask of claim 7, wherein the retaining element is an annular elastic band.

9. The mask of claim 1, wherein the transparent body has an interior surface, wherein the transparent body is sufficiently rigid maintain the interior surface spaced from the mouth of the wearer.

10. The mask of claim 1, wherein the filter media comprises nonwoven polymer.

11. The mask of claim 1, wherein the apertures are disposed so that the apertures are not intersected by a line of sight extending from a position directly in front of the mask to the mouth of the user.

12. The mask of claim 1, wherein the at least one aperture comprises at least four apertures.

13. The mask of claim 1, wherein each aperture of the at least one aperture has an area of at least one square inch.

14. The mask of claim 1, wherein each aperture of the at least one aperture has an area of no greater than 3 square inches.

15. The mask of claim 1, wherein a collective area defined by the at least one aperture is at least 5 square inches.

16. The mask of claim 1, further comprising at least one strap that is configured to secure the transparent body to the head of the user.

17. The mask of claim 1, wherein the transparent body comprises polymer.

18. A method of preparing a mask for use on a face of a wearer having a head, a face, a nose, and a mouth, the mask comprising: a transparent body defining a peripheral rim that is configured to engage the face of the wearer, wherein the transparent body is configured to simultaneously cover the mouth and the nose of the wearer, wherein the transparent body defines at least one aperture wherein, the transparent body defines a circumferential surface around each aperture of the at least one aperture, the method comprising:
positioning respective a filter media across each aperture of the at least one aperture of the transparent body; and
biasing the respective filter media against the circumferential surface around each aperture with a respective retaining element.

19. The method of claim 19, further comprising:
disengaging the respective retaining element at each aperture of the at least one aperture;
removing the respective filter media from each aperture;
positioning a respective new filter media across each aperture of the at least one aperture of the transparent body; and
biasing the respective new filter media against the circumferential surface around each aperture with the respective retaining element.

20. The method of claim 20, further comprising sanitizing the transparent body.
